(19) United States
(12) Patent Application Publication
(10) Pub. No.: US 2004/0258111 A1
(43) Pub. Date: Dec. 23, 2004

(54) Arrangement of a plurality of high-power diode lasers

(76) Inventors: Guido Bonati, Weimar (DE); Steffen Berg, Jena (DE); Lothar Behr, Jena (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/869,971

(22) Filed: Jun. 16, 2004

(30) Foreign Application Priority Data
Jun. 20, 2003 (DE) 103 28 440.0

(51) Int. Cl. H01S 3/04; H01S 3/00

(52) U.S. Cl. 372/36; 372/38.09

(57) ABSTRACT

In an arrangement of a plurality of high-power diode lasers, each of which contains a semiconductor laser between a heatsink and a cover element, the semiconductor lasers being connected in series by their electrical contacts, it is the object of the invention to delay the need for exchanging interconnected high-power diode lasers as long as possible in the event of failure of a semiconductor laser in order to increase operating life. In order to meet this object, the electrical contacts of each semiconductor laser are connected in parallel to an electronic switching device for taking over the flow of current in the event of outage of the semiconductor laser.

### CROSS-REFERENCE TO RELATED APPLICATIONS

This application claims priority of German Application No. 103 28 440.0, filed Jun. 20, 2003, the complete disclosure of which is hereby incorporated by reference.

### BACKGROUND OF THE INVENTION

a) Field of the Invention

The invention is directed to an arrangement of a plurality of high-power diode lasers, each of which contains a semiconductor laser between a heatsink and a cover element, the semiconductor lasers being connected in series by their electrical contacts.

b) Description of the Related Art

High-power diode laser arrangements are used for industrial laser material processing, for pumping solid state lasers and in medical techniques. The semiconductor lasers in the high-power diode laser arrangements which are usually constructed as laser diode bars are normally electrically connected in series in order to achieve the required radiation outputs.

However, an electrical series connection, in which the requirements for power supply equipment and electrical lines need not be as strict as those applied to parallel connections, has the disadvantage that in the event of failure of a laser diode bar the flow of electricity is interrupted and all of the rest of the high-power diode lasers can be put out of operation so that it is often necessary to exchange the interconnected laser elements in their entirety.

### OBJECT AND SUMMARY OF THE INVENTION

Therefore, it is the primary object of the invention to delay the need for exchanging the interconnected high-power diode lasers as long as possible in the event of failure of a semiconductor laser in order to increase the operating life.

According to the invention, this object is met by an arrangement of a plurality of high-power diode lasers of the type mentioned above in that the electrical contacts of each semiconductor laser are connected in parallel to an electronic switching device for taking over the flow of current in the event of outage of the semiconductor laser.

In a preferred construction, the electronic switching device is arranged between the heatsink and the cover element so as to be integrated in the high-power diode laser. However, e.g., in encapsulated high-power diode lasers, it may also be advantageous when the electronic switching device is placed outside of the high-power diode laser.

The electronic switching device should comprise at least one semiconductor diode as switching element or, more preferably, a series connection of a plurality of semiconductor diodes which are either stacked one on top of the other or can be arranged in a plane.

One construction provides discrete components for the semiconductor diodes, while the semiconductor diodes are constructed as a hybrid component in another construction.

It is particularly advantageous when the semiconductor diodes which are connected in series are constructed as a hybrid component in which a substrate layer carries a vertical series of layers formed of two pairs of n-doped and p-doped layers, a neutral layer being provided between the pairs of layers. While the bottom pair has an electrical through-contact through the bottom n-doped layer to the heatsink, the top pair with the p-doped layer on top is electrically connected directly to the cover element.

For improved thermal discharge of power losses, it is advantageous when the semiconductor diodes which are connected in series are constructed as a hybrid component and are arranged substantially in a plane between two substrate layers situated in parallel and when each of the substrate layers has a through-contact for an electrical connection to the heatsink and cover element, respectively.

In another construction, the electronic switching device can also be constructed as a passive dielectric which is arranged as a layer on an electrically conducting carrier, wherein the dielectric is connected to the cover plate and the electrically conducting carrier makes electrical contact with the heatsink.

Further, the invention can be constructed in such a way that the electronic switching device, when not constructed with two terminals, is further supplied with an auxiliary voltage as is the case when transistors or thyristors serve as switching elements.

The invention will be described more fully in the following with reference to the schematic drawings.

### BRIEF DESCRIPTION OF THE DRAWINGS

In the drawings:

FIG. 1 is a side view showing the basic construction of a high-power diode laser;

FIG. 2 shows an array-type arrangement of high-power diode lasers;

FIG. 3 shows high-power diode lasers which are stacked one on top of the other;

FIG. 4 shows a circuit arrangement for the electronic switching element with semiconductor diodes connected in series;

FIG. 5 shows a stack of discrete semiconductor diodes which are connected in a high-power diode laser between the n-contact and p-contact;

FIG. 6 shows a switching element in the form of a hybrid element with a vertical series of layers which is integrated in the high-power diode laser;

FIG. 7 shows another construction of a switching element in the form of a hybrid element which is integrated in the high-power diode laser;

FIG. 8 shows a passive switching element integrated in the high-power diode laser;

FIG. 9 shows a typical characteristic line for the high-power diodes that are used; and

FIG. 10 shows characteristic lines for an electronic circuit, e.g., a transistor and the dielectric layer (straight-line curve) after breakdown.

### DESCRIPTION OF THE PREFERRED EMBODIMENTS

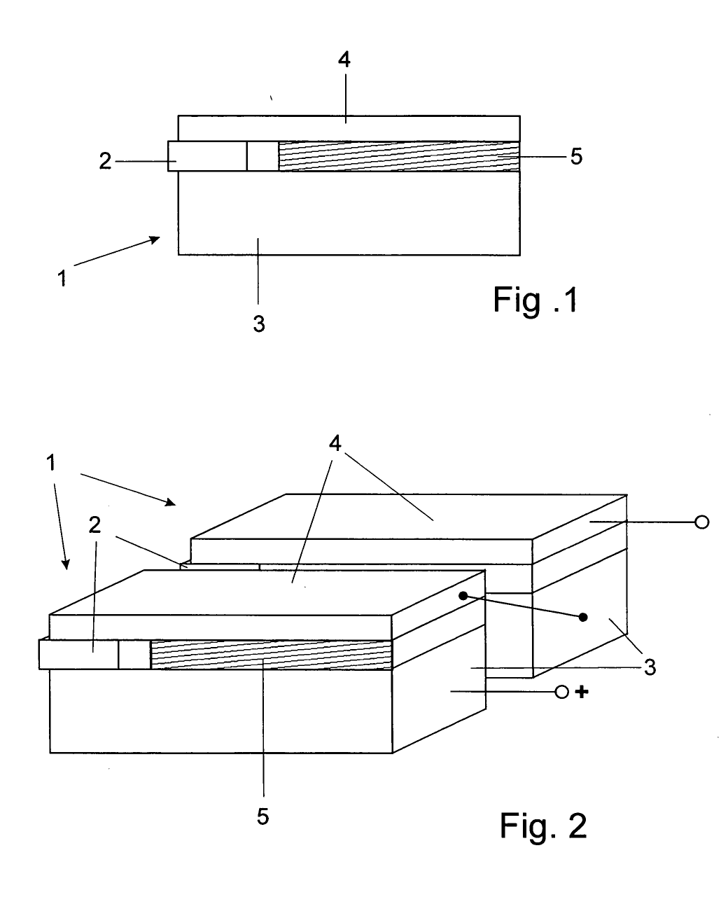

In the sandwich-type high-power diode laser 1 shown in FIG. 1, a semiconductor laser constructed as laser diode bars 2 is arranged on a heatsink 3 which is preferably made of copper and which serves simultaneously as p-contact. An electrically conducting cover element 4 forms the n-contact for the laser diode bars 2 and is electrically separated from the heatsink 3 by an insulating layer 5 for potential separation of the p-side from the n-side.

The use of the term semiconductor laser should not be interpreted as limiting in any way. Aside from the bar form already mentioned, other structural shapes such as individual chips are, of course, also suitable for the invention. However, the output power should be above 10 W.

A connection serving to increase power can be carried out conventionally according to FIG. 2, whereby the high-power diode lasers 1 are arranged next to one another in a plane in direction of the longitudinal dimension of the laser diode bars 2, and the laser diode bars 2 are electrically connected in series so that a radiation source is formed with a line-shaped laser beam bundle profile.

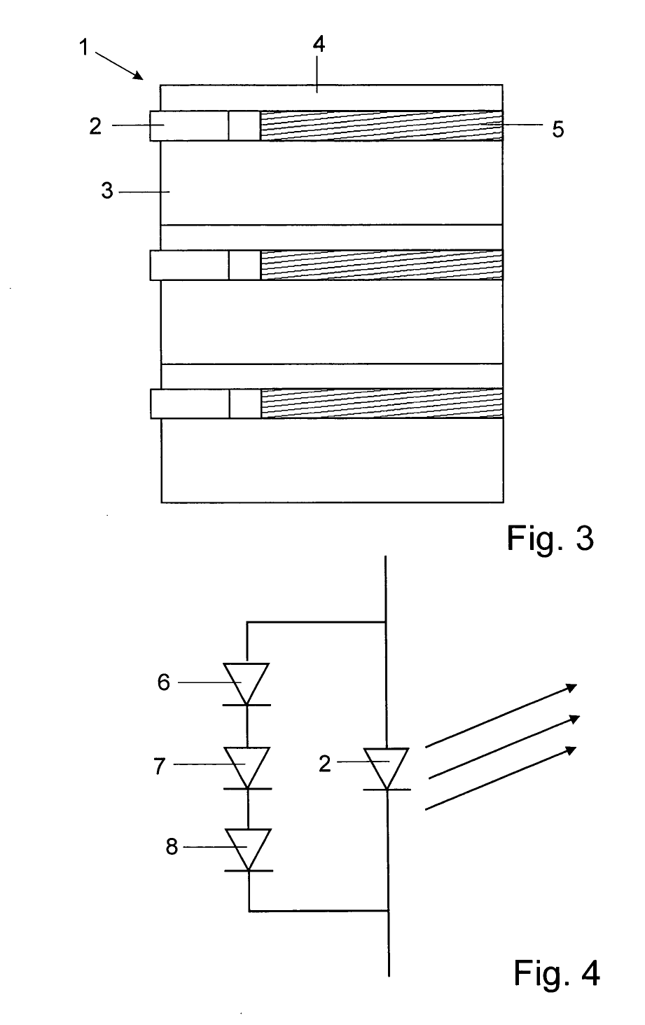

In another construction according to FIG. 3, the high-power diode lasers 1 are arranged one on top of the other and form a stack.

In the circuit arrangement shown in FIG. 4, three semiconductor diodes 6, 7 and 8 connected in series are connected in parallel to the p-contact and n-contact of the high-power diode laser 1, wherein their through-voltage (breakpoint voltage) is greater than the through-voltage of the high-power diode laser 1 which is typically 1.1 V to 1.8 V.

In the event of failure of a high-power diode laser incorporated in a series connection of high-power diode lasers, the resulting high resistance causes the semiconductor diodes 6, 7 and 8 to take over the flow of current past the high-impedance high-power diode laser so as to ensure operation of the remaining intact high-power diode lasers.

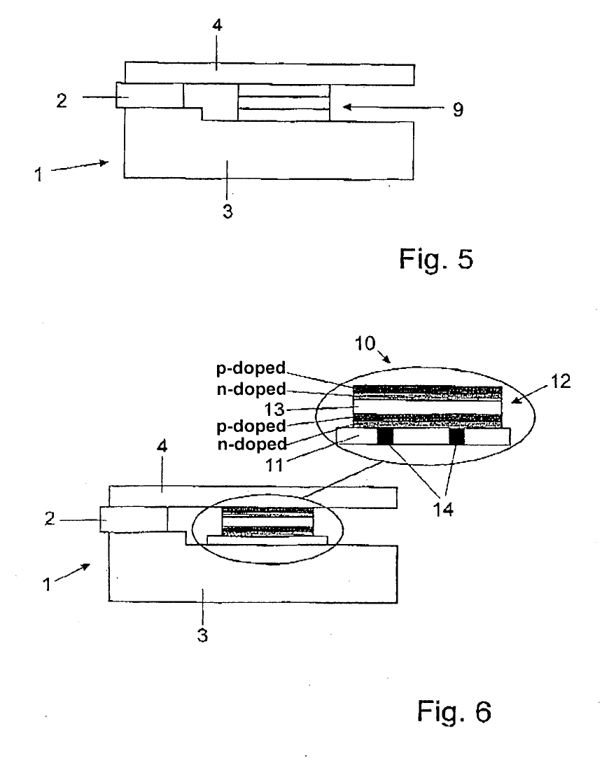

In the construction shown in FIG. 5, the insulating layer 5 provided in FIG. 1 is replaced by a layer construction 9 in which each of the layers corresponds to a discrete semiconductor diode 6, 7 and 8.

The hybrid component 10 shown in FIG. 6 which is preferably integrated in the high-power diode laser 1 and which is connected between the heatsink 3 and cover element 4 likewise has a layer construction. The hybrid element 10 realizes the diode series connection in that a substrate layer 11 carries a vertical series of layers 12 comprising two pairs of n-doped and p-doped layers, a neutral layer 13 being provided between the pairs of layers. While an electric through-contact 14 of the bottom n-doped layer to the heatsink 3 (p-contact) is required in the bottom pair, the top pair with the upper p-doped layer is electrically connected directly to the cover element 4 (n-contact).

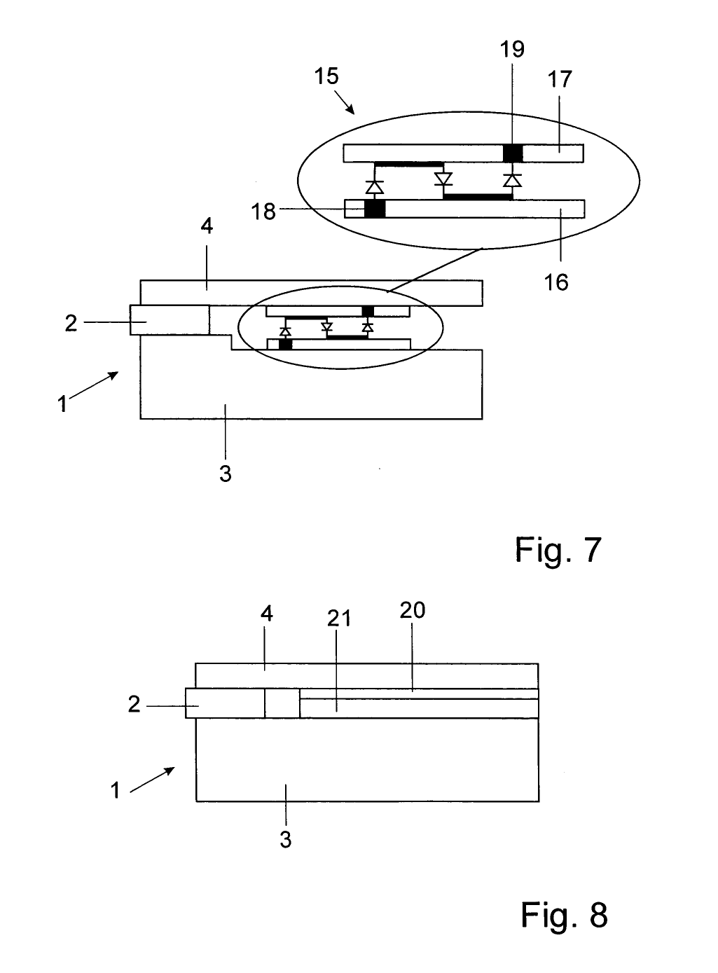

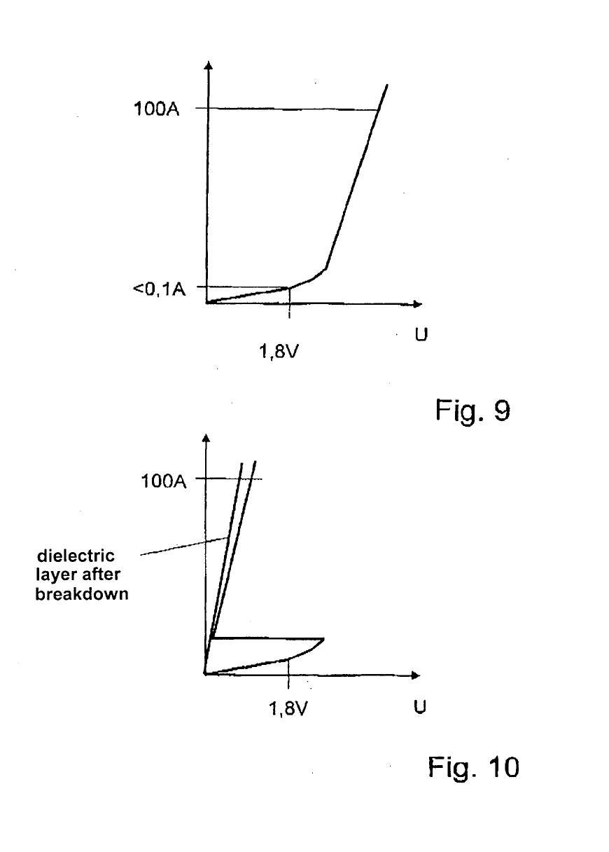

The hybrid component 15 according to FIG. 7 is similarly integrated in the high-power diode laser 1 and is connected between the heatsink 3 and the cover element 4 like the hybrid component 10 in FIG. 6. Unlike this construction, however, the semiconductor diodes connected in series are arranged substantially in a plane between two substrate layers 16, 17 lying parallel to one another and a through-contact 18 and 19, respectively, is made by each of the substrate layers 16, 17 to the heatsink 3 (p-contact) on the one hand and to the cover element 4 (n-contact) on the other hand so that a parallel connection is ensured again.

While the integration of the electronic switching device in the high-power diode laser 1 does present difficulties due to the low ceiling height of about 0.25 to 0.5 mm, it offers the advantage that vertically stacked high-power diode lasers 1 as well as high-power diode lasers 1 arranged side by side can be protected when a switching device of this type is accommodated in each of the high-power diode lasers 1.

The invention is not limited to the semiconductor diodes predominantly used herein or to semiconductor components.

For example, active components which work with an additional auxiliary voltage, e.g., transistors or thyristors, can be used instead of semiconductor diodes.

Instead of semiconductor components, suitable foils or dielectric layers which lose their insulating effect when the flow voltage of the high-power diode laser 1 is exceeded due to a defect in the laser diode bar 1 can also be used as a switching device. This can possibly also be irreversible.

In a construction of this type according to FIG. 8, a layer-shaped dielectric 20 is located between the heatsink 3 and the cover element 4 and is arranged on an electrically conducting carrier 21 and placed in direct contact with the cover plate 4 (n-contact). The electronically conducting carrier 21 is electrically connected to the heatsink 3 (p-contact).

The layer-shaped dielectric which otherwise acts in an electrically insulating manner is selected in such a way that the breakdown voltage is exceeded when a high impedance develops due to functional failure of the laser diode bar 2 and current is conducted across the dielectric 20.

While the foregoing description and drawings represent the invention, it will be obvious to those skilled in the art that various changes may be made therein without departing from the true spirit and scope of the present invention.

What is claimed is:

1. An arrangement of a plurality of high-power diode lasers, comprising:
each diode laser containing a semiconductor laser between a heatsink and a cover element;
said semiconductor lasers being connected in series by their electrical contacts;
wherein the electrical contacts of each semiconductor laser are connected in parallel to an electronic switching device for taking over the flow of current in the event of outage of the semiconductor laser.

2. The high-power diode laser arrangement according to claim 1, wherein the electronic switching device is arranged between the heatsink and the cover element so as to be integrated in the high-power diode laser.

3. The high-power diode laser arrangement according to claim 1, wherein the electronic switching device is placed outside of the high-power diode laser.

4. The high-power diode laser arrangement according to claim 2, wherein the electronic switching device comprises at least one semiconductor diode as switching element.

5. The high-power diode laser arrangement according to claim 4, wherein the electronic switching device comprises a series connection of a plurality of semiconductor diodes.

6. The high-power diode laser arrangement according to claim 5, wherein the semiconductor diodes which are connected in series are stacked one on top of the other.

7. The high-power diode laser arrangement according to claim 5, wherein the semiconductor diodes which are connected in series are arranged in a plane.

8. The high-power diode laser arrangement according to claim 6, wherein the semiconductor diodes which are connected in series are constructed as a hybrid component (10 or 15).

9. The high-power diode laser arrangement according to claim 6, wherein the semiconductor diodes which are connected in series are constructed as a hybrid component in which a substrate layer carries a vertical series of layers formed of two pairs of n-doped and p-doped layers, a neutral layer being provided between the pairs of layers, wherein the bottom pair has an electrical through-contact of the bottom n-doped layer to the heatsink, and wherein the top pair with the p-doped layer on top is electrically connected directly to the cover element.

10. The high-power diode laser arrangement according to claim 7, wherein the semiconductor diodes which are connected in series are constructed as a hybrid component and are arranged substantially in a plane between two substrate layers situated in parallel to one another, and wherein each of the substrate layers has a through-contact for an electrical connection to the heatsink and cover element.

11. The high-power diode laser arrangement according to claim 2, wherein the electronic switching device is constructed as a passive dielectric.

12. The high-power diode laser arrangement according to claim 11, wherein the dielectric is arranged as a layer on an electrically conducting carrier, wherein the dielectric is connected to the cover plate and the electrically conducting carrier makes electrical contact with the heatsink.

13. The high-power diode laser arrangement according to claim 2, wherein the electronic switching device comprises transistors or thyristors serve as switching elements.

14. The high-power diode laser arrangement according to claim 2, wherein the electronic switching device is constructed with two terminals.

15. The high-power diode laser arrangement according to claim 2, wherein the electronic switching device is supplied additionally by an auxiliary voltage.
